(19) United States
(12) Patent Application Publication
(10) Pub. No.: US 2008/0313981 A1
(43) Pub. Date: Dec. 25, 2008

(54) Tiled Panel Shutter

(76) Inventors: Elizabeth Marie Donley, Montross, VA (US); John William Donley, Montross, VA (US)

Correspondence Address: Cynthia Marie Young, 47 Abel Place, Media, PA, 19063, US

(21) Appl. No.: 12/142,754

(22) Filed: Jun. 19, 2008

Related U.S. Application Data
(60) Provisional application No. 60/945,429, filed on Jun. 21, 2007.
(60) Provisional application No. 60/950,898, filed on Jul. 20, 2007.

(51) Int. Cl. E06B 3/30

(52) U.S. Cl. 52/203

(57) ABSTRACT

A window shutter comprising tiled panels that may be either fixed or replaceable. Specifically, the shutter comprises a frame with one or more panels within the frame, and the panels are affixed with one or more tiles. Replaceable panels float within the frame and are held in place with a removable fastener. These shutters combine the design flexibility inherent in ceramic, glass, porcelain, clay, stone, cork, wood, metal, plastic and other decorative tiles with the flexibility of allowing the appearance of the shutter to be changed without removing the shutter from the building structure.

### CROSS-REFERENCE TO RELATED APPLICATIONS

This application claims the benefit of U.S. Provisional Application No. 60/945,429, filed Jun. 21, 2007, and U.S. Provisional Application No. 60/950,898, filed Jul. 20, 2007.

### BACKGROUND

As a result of an effort to cut costs and streamline the process of mass-producing houses, most houses are very similar in appearance. The exterior appearance of a property can be improved by painting, applying siding, erecting an addition, or putting ornamentation on the exterior of the property. Most of these improvements require significant time and energy to complete and, in general, are permanent changes to the property.

One common form of ornamentation is the use of window shutters to add character to, or change the appearance of a structure. However, decorative options for shutters have generally been limited to choice of color and minor variations in trim and molding.

Information relevant to attempts to address these problems can be found in U.S. Pat. Nos. 5,636,676, 5,669,185, 5,848,505, 6,499,264, 6,658,793, and 6,886,298 and U.S. Patent Application Nos. 20040187417 and 20060150544 and at www.coppermoonwoodworks.com. However, each one of these references suffers from one or more of the following disadvantages: the references do not show shutters that are customizable; the references do not show shutters with tiled panels; and the references fail to show shutters with tiled panels that may be easily replaced creating a changeable appearance for the exterior or interior of a property.

For the foregoing reasons, there is a need for decorative options for the exterior appearance of a property in the form of unique and customizable shutters. In particular, there is a need for shutters with tiled panels so that the exterior (or even the interior) of a home can stand apart from the typical mass-production property.

### SUMMARY

The versions of the present invention are directed to a tiled panel shutter that satisfies the need for decorative options for a property in the form of unique and customizable shutters. Specifically, the versions of the present invention include a decorative or operable building shutter of the type normally attached to the interior or exterior wall of a structure on either side of a window, door, or other opening in the structure or as a standalone decoration. The shutter is a change from the traditional raised panel shutter design and creates greater flexibility in appearance and aesthetic choices as well as the use of an invisible mounting system. It incorporates the design flexibility inherent in ceramic, glass, porcelain, clay, stone, cork, wood, metal, plastic and other decorative tiles in a system that allows the appearance to be changed without removing the shutter from the building. This approach describes a standard method of construction in which a replaceable tiled panel is used in lieu of the traditional wooden raised panel.

A shutter having features of the present invention comprises a frame comprised of two parallel vertical stiles separated by a top and bottom rail to create an interior space into which one or more tiled panels are placed. Multiple panels are separated by an interior rail. The stiles and rails that comprise the frame members may be constructed of any suitable material, including, but not limited to, wood, PVC board, vinyl, plastic, metal, and composite board. The panel is typically constructed of a rigid, weather-resistant material (when used in exterior applications), including, but not limited to, PVC, tile backer board, or aluminum. Decorative tiles made of ceramic, glass, porcelain, clay, stone, cork, wood, metal, plastic, or other suitable material, are adhered to the panel using a flexible, weather-resistant (when used in exterior applications) adhesive. Trim pieces made of any suitable material are affixed around the perimeter of the tiled area. These trim pieces are affixed to the panel using glue or any suitable fastener. Spaces between tiles and between the tiles and the trim are filled with a flexible, weather-resistant (when used in exterior applications) grout. The panels are mounted permanently to the frame by placing the panel into a groove that has been cut into the top and bottom rails as well as the interior edges of both stiles.

Alternatively, the panels are not permanently affixed to the stiles and rails, but rather the top edge of each panel floats in a groove which is routed along the interior edge of the top rail, while the sides of the panels rest on a rabbet which is cut into the face of the interior edges of the stiles, and the bottoms of the panels either rest in a rabbet which is cut into the face of the interior edge of the bottom rail or in a groove which is routed along the interior edge of the bottom rail. When the bottom of the panel rests on a rabbet that has been cut into the bottom rail, a screw or other suitable fastener is inserted into a hole drilled through the bottom trim piece and panel, or the panel is attached to the frame using magnets, Velcro, or other suitable fastener, to affix the panel to the back portion of the rabbet or into the face of the bottom rail. This allows the panel to be replaced without removing the shutter from the wall by first removing the fastener, then pulling the bottom of the panel out and away from the bottom rabbet and, finally, sliding the panel down and out of the top groove until it is free of the frame. Alternatively, when the bottom of the panel rests in a groove which has been cut into the bottom rail, the top groove is cut deeper than the bottom groove, such that the panel may be removed by first removing the top trim, then sliding the panel up into the top groove until the bottom of the panel is clear of the bottom groove, then pulling the bottom of the panel away from the bottom rail and, finally, sliding the panel down and out of the top groove until it is free of the frame.

This approach provides a simple design that is easy to manufacture using readily-available materials, yet offers much greater flexibility in the appearance and aesthetics of the shutter by allowing the appearance of the shutter to be changed without removing the shutter from the building structure. By slight modifications to the dimensions, it can be adapted to accept almost any commercial or custom tile, which is suitable for use in the intended climate if the shutter is to be used in an exterior application. This is made possible by the combination of a floating panel and flexible adhesive and grout such that the dissimilar materials used in the construction of this shutter design can expand and contract at different rates in response to changes in temperature and humidity with minimal risk of failure. The design has the added advantage that the shutter may be attached to the building structure using z-brackets or other suitable mounting system and secured to the structure through the frame opening with the panels removed such that no brackets or fasteners are visible once the panels are replaced in the frames. Alternatively, the shutters can be made operable by using conventional shutter hinges. The shutters may be attached to the interior or exterior wall of a structure on either side of a window, door, or other opening in the structure or as a standalone decoration.

### BRIEF DESCRIPTION OF THE SEVERAL VIEWS OF THE DRAWINGS

These and other features, aspects, and advantages of the present invention will become better understood with regard to the following description, appended claims, and accompanying drawings where:

FIG. 1 shows an elevation view of a shutter with one tiled panel containing six tiles;

FIG. 2 shows a cross-section of the shutter of FIG. 1 at a point which intersects the panel;

FIG. 3 shows a cross-section of the shutter of FIG. 1, which illustrates one possible method for joining the stiles and rails using a tongue and groove joint;

FIG. 4A shows a vertical section of a typical panel construction where a groove has been cut into the top rail and a rabbet has been cut into the bottom rail, the bottom of the panel rests in a rabbet cut into the bottom rail, and the panel is affixed to the frame by placing the top of the panel into the groove in the top rail and employing a screw or other suitable fastener to attach the bottom of the panel to the bottom rail;

FIG. 4B shows the first step in replacing the panel of FIG. 4A: removing or disengaging the fastener used to affix the bottom of the panel to the bottom rail;

FIG. 4C shows the second step in replacing the panel of FIG. 4A: pulling the bottom of the panel out and away from the shutter until the bottom of the panel clears the rabbet in the bottom rail;

FIG. 4D shows the third step in replacing the panel of FIG. 4A: pulling the panel down and out of the groove in the top rail until the panel is free of the frame;

FIG. 5A shows a vertical section of another version of a typical panel construction where a groove has been cut into the top and bottom rails, and the panel is affixed to the frame by sliding the top of the panel into the groove in the top rail until the bottom of the panel clears the bottom rail, then dropping the bottom of the panel into the groove in the bottom rail and, finally, securing a removable top trim piece using a screw or other suitable fastener to lock the panel in place;

FIG. 5B shows the first step in replacing the panel of FIG. 5A: removing or disengaging the fastener used to affix the top trim piece to the panel;

FIG. 5C shows the second step in replacing the panel of FIG. 5A: lifting the panel up into the groove in the top rail until the bottom of the panel clears the groove in the bottom rail.

FIG. 5D shows the third step in replacing the panel of FIG. 5A: pulling the bottom of the panel out until it clears the bottom rail;

FIG. 5E shows the fourth step in replacing the panel of FIG. 5A: pulling the panel down and out of the groove in the top rail until the panel is free of the frame;

FIG. 6 shows a vertical section of another version of a typical panel construction where the bottom of the panel rests in a rabbet that has been cut into the bottom rail similar to the option illustrated in FIG. 4A, except that, in this alternative, the panel is affixed to the face of the bottom rail using an alternative trim design;

FIG. 7 shows a vertical section of another version of a typical panel construction where the bottom of the panel rests in a groove that has been cut into the bottom rail similar to the option illustrated in FIG. 6, except that, in this alternative, the top trim piece is permanently affixed to the panel such that the panel is not replaceable;

FIG. 8 shows a cross-section of another version of a shutter at a point which intersects one of the panels, where the panel is not replaceable and rests in grooves cut into the interior edges of the stiles rather than resting on a rabbet cut into the stiles; and

FIG. 9 shows an elevation view of another version of a shutter, where the shutter has two panels.

### DESCRIPTION

The versions of the present invention comprise a shutter comprising a generally rectangular frame, though any shape shutter is contemplated, and at least one panel affixed with tiles.

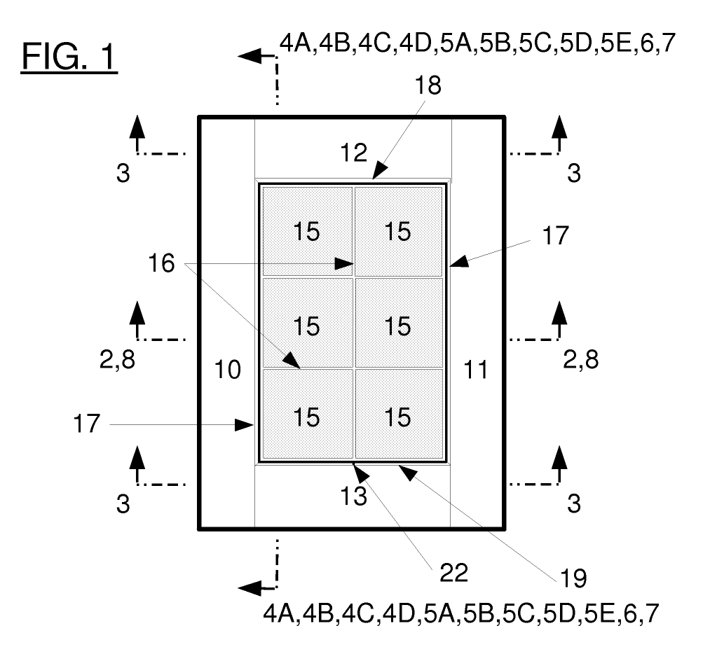

With reference to the Figures, in which like numerals represent like or corresponding parts, a frame is constructed as illustrated in FIG. 1, consisting of two stiles identified as 10 and 11, connected at the top and bottom with two rails identified as 12 and 13, using any suitable method of joinery, including but not limited to, tongue and groove, wooden or plastic biscuits, mortise and tenon, pocket screws, or dowels. FIG. 3 illustrates one possible method for joining the stiles and rails using a tongue and groove joint. The stiles and rails that comprise the frame members may be constructed of any suitable material, including, but not limited to, wood, PVC board, vinyl, plastic, metal, or composite board.

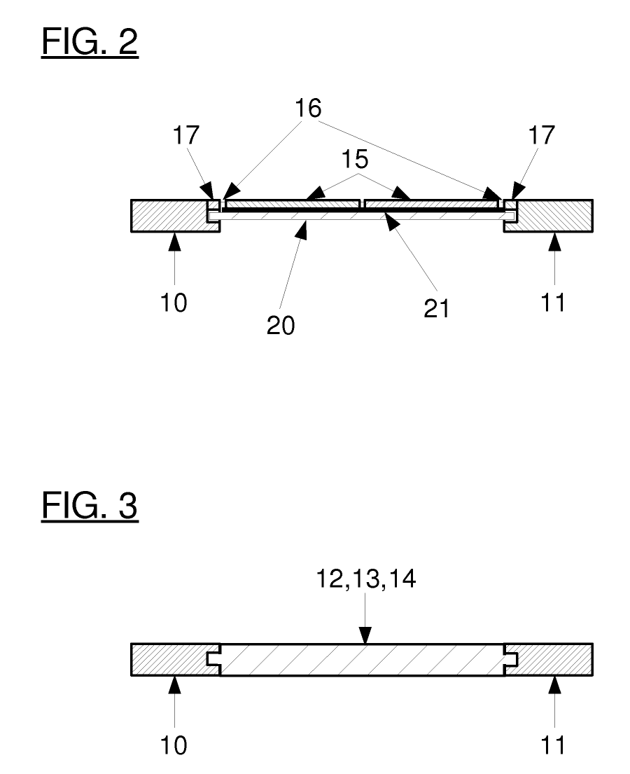

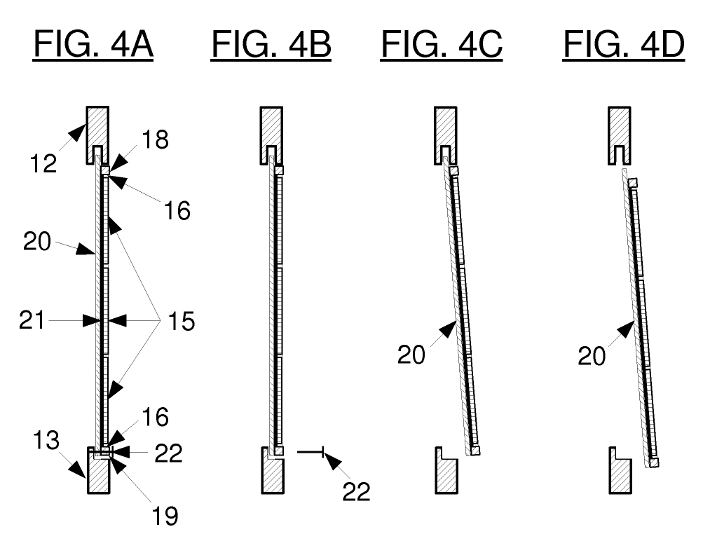

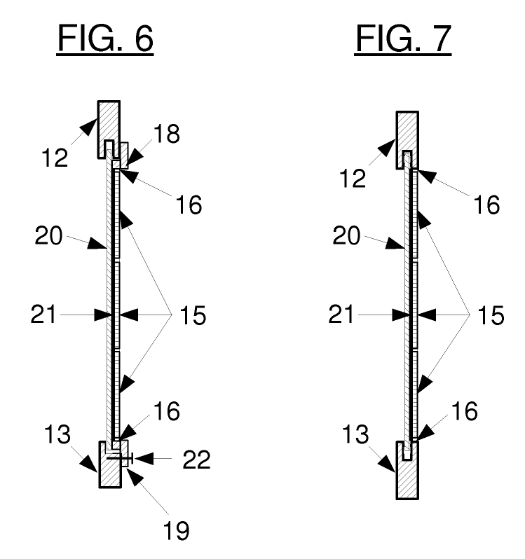

A panel identified as 20 is mounted within the interior space of this frame. The panel may be composed of PVC, tile backer board or any other suitable rigid and weather-resistant (when used in exterior applications) material. The panel is not rigidly affixed to the frame, but rather floats within a groove cut or molded into the top rail as illustrated in FIG. 4A and rests on a rabbet cut or molded into the interior edges of the stiles and bottom rail as illustrated in FIG. 2. The panel is held in place by a fastener such as a screw or bolt, or attached to the frame using magnets, Velcro, or other suitable fastener, identified as 22, which is fastened to the back portion of the bottom rabbet as illustrated in FIG. 4A or directly onto the face of the bottom rail as illustrated in FIG. 6. The panel may be removed as illustrated in FIGS. 4B, 4C, and 4D by first removing or disengaging the fastener identified as 22, pulling the bottom of the panel out and away from the shutter until the bottom of the panel is clear of the rabbet in the bottom rail identified as 13, and, finally, pulling the panel down and out of the groove in the top rail identified as 12 until it is clear of the frame. Installation of a new panel is the reverse of this procedure.

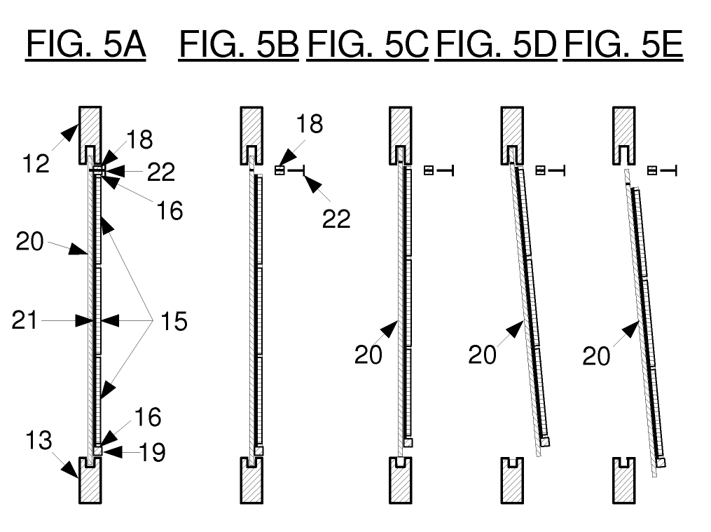

Alternatively, the panel may float within a groove cut or molded into the top and bottom rails as illustrated in FIG. 5A and rest on a rabbet cut or molded into the interior edges of the stiles as illustrated in FIG. 2. In this case, the groove in the top rail identified as 12 is at least twice as deep as the groove in the bottom rail identified as 13. The top trim piece, identified as 18, is made removable as illustrated in FIG. 5B and is wider than the depth of the groove in the bottom rail. This trim or molding piece is affixed to the panel using screws, bolts, or other suitable fasteners identified as 22. The panel may be removed as illustrated in FIGS. 5B, 5C, 5D, and 5E by first removing or disengaging the fastener identified as 22 and the trim piece identified as 18, lifting the panel up into the groove in the top rail identified as 12 until the bottom of the panel is clear of the groove in the bottom rail identified as 13, pulling the bottom of the panel out and away from the shutter until it is clear of the bottom rail identified as 13, and, finally, pulling the panel down and out of the groove in the top rail identified as 12 until it is clear of the frame. Installation of a new panel is the reverse of this procedure.

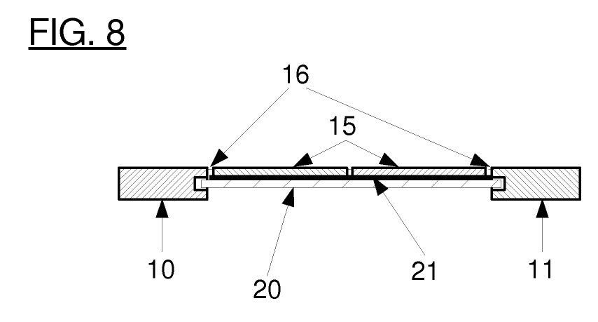

The panel may also be mounted permanently in the frame such that it is not removable, as illustrated in FIG. 7. In this case, grooves are cut into the interior edges of the top and bottom rails, but no fasteners are used and the trim pieces are either absent or are permanently affixed to the frame or panel. The panel may either rest on rabbets cut into the interior edges of the stiles as illustrated in FIG. 2, or float in grooves cut into the interior edges of the stiles as illustrated in FIG. 8. Alternatively, the panel and frame may be constructed so that they are a single unit, and tiles are affixed to the panel portion of the unit.

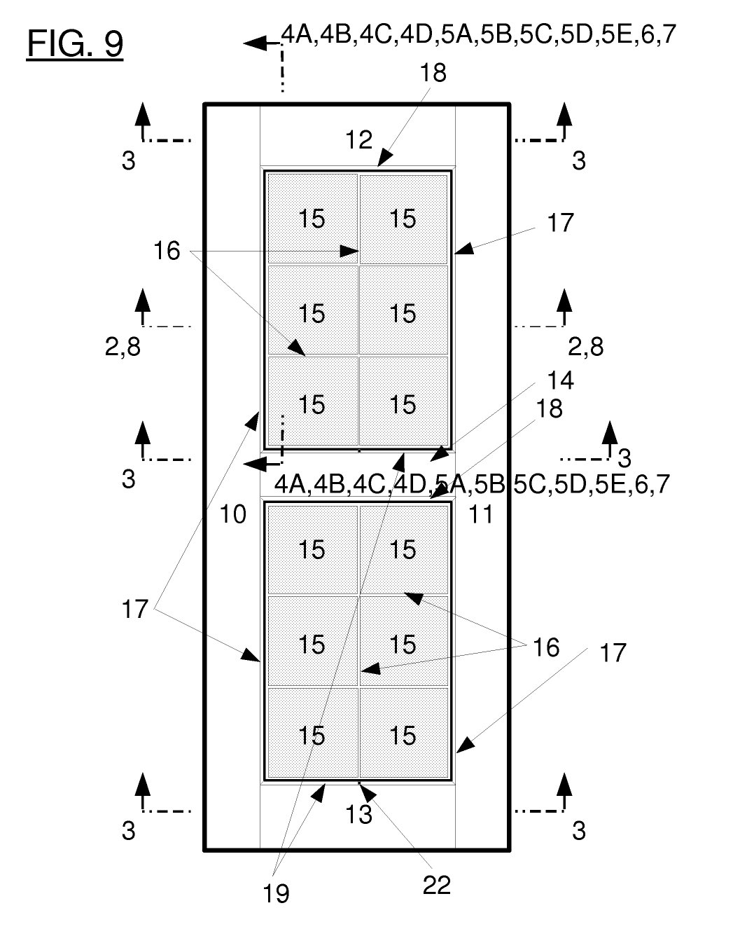

A shutter may contain one or more such panels. In the event two or more panels are used as illustrated in FIG. 9, each pair of adjacent panels is separated by an interior rail identified as 14, which will serve as the bottom rail for the panel above and the top rail for the panel below. As such, a groove is incorporated into the top of each interior rail and a rabbet or groove is incorporated into the bottom of each interior rail to accommodate both panels using the same methods as described above with respect to the stiles and top and bottom rails.

One or more tiles made of ceramic, glass, porcelain, clay, stone, cork, wood, metal, plastic, or other suitable material identified as 15 are affixed to each panel using a suitable weather-resistant (when used in exterior applications), flexible adhesive identified as 21. FIG. 1 illustrates a panel having a major portion of its surface covered with tiles. Trim or molding pieces identified as 17 and 19 are affixed to the panel around the perimeter of the tiled area using an adhesive or suitable fastener. These trim pieces are optional if the panel is permanently mounted in the frame and is not removable as illustrated in FIGS. 7 and 8. A weather-resistant (when used in exterior applications), flexible grout identified as 16 is applied to fill the gaps between the tiles and between the tiles and the trim or molding pieces.

Although the present invention has been described in considerable detail with reference to certain preferred versions thereof, other versions are possible. For example, the shutters may be attached to the interior or exterior wall of a structure on either side of a window, door, or other opening in the structure or as a standalone decoration. The number of panels and tiles may be varied to accommodate the preferred width of the shutter, the size of the window or door adjacent to which the shutter is to be mounted, the size of tiles to be affixed to each panel, the size of the tiles to be used, and the aesthetic preferences of the designer. Furthermore, the number of columns of tiles on the panels may be varied to accommodate the width of the shutter and the size and number of tiles to be affixed to each panel. Panels made of wood, PVC board, vinyl, plastic, metal, composite board, or other suitable material or louvered panels may be substituted for the tiled panels, with or without trim pieces, and affixed to the frame using the same fastening system. Designs or images may also be cut into the panels and combined with transparent or translucent tile to add an additional decorative element. Therefore, the spirit and scope of the appended claims should not be limited to the description of the preferred versions contained herein.

The previously described versions of the present invention have many advantages, including they incorporate the design flexibility inherent in ceramic, glass, porcelain, clay, stone, cork, wood, metal, plastic and other decorative tiles in a system that satisfies the need for decorative options for a property in the form of unique and customizable shutters. This approach provides a simple design that is easy to manufacture using readily-available materials, yet offers much greater flexibility in the appearance and aesthetics of the shutter by allowing the appearance of the shutter to be changed without removing the shutter from the building structure. By slight modifications to the dimensions, it can be adapted to accept almost any commercial or custom tile, which is suitable for exterior use in the intended climate. This is made possible by the combination of a floating panel and flexible adhesive and grout such that the dissimilar materials used in the construction of this shutter design can expand and contract at different rates in response to changes in temperature and humidity with minimal risk of failure. The design has the added advantage that the shutter may be attached to the building structure using z-brackets or other suitable mounting system and secured to the structure through the frame opening with the panels removed such that no brackets or fasteners are visible once the panels are replaced in the frames. Alternatively, the shutters can be made operable by using conventional shutter hinges.

What is claimed is:

1. A shutter comprising:
(a) a frame; and
(b) at least one panel within the frame, the panel comprising at least one tile affixed to the surface of the panel.

2. The shutter as recited in claim 1, wherein the frame comprises at least one predetermined sized opening.

3. The shutter as recited in claim 2, further comprising at least one interior rail in the frame to separate multiple panels.

4. The shutter as recited in claim 1, wherein the frame and the panel are a single unit.

5. The shutter as recited in claim 1, wherein the tiles cover a major portion of the surface of the panel.

6. A shutter comprising:
(a) a frame comprising at least one predetermined sized opening;
(b) at least one replaceable panel fitting within the opening of the frame, the panel comprising at least one tile affixed to the surface of the panel; and
(c) an attachment means for attaching the panel to the frame so that the panel can be removed from the frame and replaced with a different replaceable panel.

7. The shutter as recited in claim 6, further comprising at least one interior rail in the frame to separate multiple panels.

8. The shutter as recited in claim 6, wherein the tiles cover a major portion of the surface of the panel.

9. A decorative window shutter comprising:
(a) a frame comprising two parallel vertical stiles connected by a top and bottom rail creating at least one predetermined sized opening;
(b) at least one replaceable panel fitting within the opening of the frame, the panel comprising at least one tile affixed to the surface of the panel, the tiles covering a major portion of the surface of the panel; and
(c) an attachment means for attaching the panel to the frame so that the panel can be removed from the frame and replaced with a different replaceable panel.

10. The shutter as recited in claim 9, wherein the top rail comprises a groove routed along the interior edge of the top rail, the bottom rail and the stiles comprise a rabbet cut into the face of the interior edges of the stiles and the bottom rail, and the panel fits within the opening of the frame so that the panel floats in the groove of the top rail and rests in the rabbet of the stiles and bottom rail.

11. The shutter as recited in claim 9, wherein the panel floats within a groove cut or molded into the top and bottom rails and rests on a rabbet cut or molded into the interior edges of the stiles, the groove in the top rail is at least twice as deep as the groove in the bottom rail, the top trim piece is wider than the depth of the groove in the bottom rail, and the top trim piece is attached to the panel using the attachment means.

12. The shutter as recited in claim 9, further comprising at least one interior rail in the frame to separate multiple panels.

13. The shutter as recited in claim 9, further comprising a trim piece affixed to the panel around the perimeter of the tiled area.

14. The shutter as recited in claim 9, further comprising grout filling in spaces between the tiles and between the tiles and the trim piece.

15. (canceled)

16. The shutter as recited in claim 1, further comprising a design cut into the panel and covered with a translucent or transparent tile so that the design is visible through the tile.

17. The shutter as recited in claim 6, further comprising a design cut into the panel and covered with a translucent or transparent tile so that the design is visible through the tile.

18. The shutter as recited in claim 9, further comprising a design cut into the panel and covered with a translucent or transparent tile so that the design is visible through the tile.
